(19) United States
(12) Patent Application Publication
(10) Pub. No.: US 2005/0044542 A1
(43) Pub. Date: Feb. 24, 2005

(54) Method and device for optimized code checker

(75) Inventors: Gilles Grimaud, Lille (FR); Damien Deville, Lille (FR); Antorine Requet, Marseille (FR)

Correspondence Address: BURNS DOANE SWECKER & MATHIS L L P, POST OFFICE BOX 1404, ALEXANDRIA, VA, 22313-1404, US

(73) Assignee: GEMPLUS

(21) Appl. No.: 10/490,415

(22) PCT Filed: Sep. 24, 2002
(86) PCT No.: PCT/FR02/03249

(30) Foreign Application Priority Data
Sep. 24, 2001 (FR) 01 12278

(51) Int. Cl. G06F 9/445

(52) U.S. Cl. 717/174; 717/141; 717/167

(57) ABSTRACT

The verification process is applied to a programme (4) when it is being integrated into an electronic device (2), the programme being organized on the basis of types linked by parentage relationships, each type being identified by a respective code. The invention is characterized in that it comprises a phase which consists in carrying out unification of the types so as to determine their nearest common ancestor using a form of said code including a pattern of bits in accordance with a formalism which expresses the parentage of the type with which it is associated, and by performing a logical combination of the patterns assigned to the types to be unified, producing the pattern of the type which is their nearest common ancestor. The invention enables verification in devices with limited storage memory resources, in particular smart cards (2).

The invention concerns the checking of program code loaded into an electronic device, for example—but not exclusively—a device with limited memory such as a chip card or the like. More particularly, the invention is aimed at the checking of programs which are organised according to types linked by parentage relationships, in accordance with the current techniques of programming in high-level language, and is based on a checking technique which uses a process of unification of types aimed at determining their common ancestor.

The aim is to ensure that the program loaded is consistent with the specificities expected with regard to the device which integrates it. To this end, a checker is used whose tasks are typically:

to prevent:
producing and modifying pointers using explicit values,
attacking the stack (“overflow”/“underflow”); and

guaranteeing that:
each instruction has as an input the correct number of parameters and that these are correctly typed; and
every object has been initialised once and only once.

It is thus possible to filter the programs loaded before integrating them, and in particular to refuse those which could corrupt the correct functioning of the device, either intentionally by an act of malice or by programming error or hardware fault.

The overall problem of program checking will be presented in the context of devices with limited memory, in this case a chip card with so-called open architecture. This type of card makes it possible at all times to load and modify programs in high-level language. The open smart card then constitutes a self-contained and communicating virtual machine able to evolve according to new applications required by its holder.

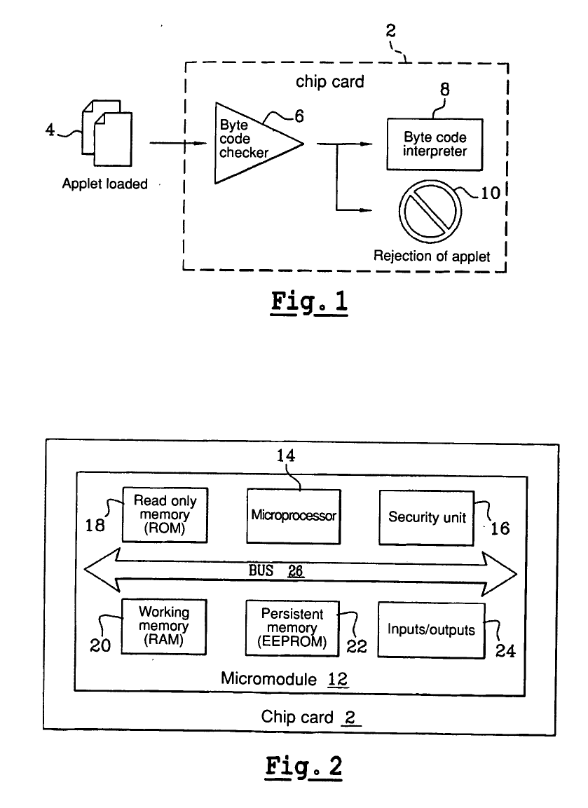

FIG. 1 illustrates the action of a check in this context. The chip card 2 is in a position to load one or more programs, in this case of the “applet” type 4.

Once the program 4 is loaded in the card, it is necessary to proceed with an integration phase in order to make it operational. The checking occurs during this phase and serves to decide whether the card must integrate the program or on the other hand reject it. This task is performed on the basis of an analysis of the byte code, or pseudo-code, which will be designated hereinafter by the dedicated term “byte code”. It is carried out by a byte code checker 6 which constitutes a functional element of the virtual machine situated upstream of the byte code interpreter 8.

In operation, the checker 6 determines that the structure of the program loaded 4 is functionally integral and compatible with what is expected with regard to the card 2. If the checker validates the program, it transmits it to the byte code interpreter 8 with a view to its execution. In the contrary case, that is to say the detection of a fault liable to endanger the card, the checker 6 demands a process (symbol represented by the FIG. 10) intended to reject the loaded program 4.

In the general case, the implementation of such a checking process substantially stresses the memory resources of the device in which the checking is being carried out. In particular, the iterative nature of the check requires many updates of the result data and therefore logic state transitions in the storage cells. Moreover, the memory space to be dedicated to the checking process may be considerable for a device with limited memory.

This is because the format of the card imposes significant restrictions in its hardware resources. This limited space is divided into six functional components, indicated schematically in FIG. 2, which constitute a micromodule 12 of the card 2, that is to say:
a microprocessor 14;
a security unit 16;
a fixed memory 18, accessible in read mode only (of the so-called ROM type (read only memory) in English terminology);
a volatile working memory 20 (of the so-called RAM type (random access memory) or possibly FlashRAM in English terminology);
a persistent memory 22, either non-volatile, which nevertheless allows writing and erasure cycles. This memory is typically produced in so-called electrically erasable and rewritable ROM memory technology, referred to as EEPROM (electrically erasable programmable read only memory) in English terminology; and
input/output interfaces 24,

the whole being connected by an internal data bus 26.

For technical reasons, the micromodule 12 of the card 2 is better provided with persistent memory capacity 22 than volatile memory 20. However, persistent memories have very slow writing time compared with a volatile memory (by a factor ranging from 1000 to 10,000), which is very detrimental to the “card” programmer.

What is more, the persistent memory 22 raises the problem of reliability related to its service life. This is because, according to the technology used, the logic transitions of the states of their storage cells during writing cause wear which depends greatly on the direction of the transition; “stressing” transitions, or operations, are then spoken of. At each stressing writing of a value in persistent memory, there exists an increasing probability that the memory cell used has a fault. In this case, the value which may be read subsequently will not correspond to that which was written. By way of example, the manufacturers guarantee a limited number of writings (between 10⁴ and 10⁶) for a persistent memory in EEPROM technology.

For memory, a persistent memory of the EEPROM type has four operations available:
reading, in order to read a value previously stored;
erasure, which consists in effecting a logic state transition from 0 to 1, the storage cells being at the 1 state by default;
writing, which consists in effecting a logic state transition from 1 to 0; and
updating, which consists in effecting a erasure followed by a writing.

The erasure operation is of the stressing type, and may give rise to a fault in the associated memory cell. The communication model between the chip card 2 and the terminal with which it communicates is standard. The card is considered to be a server controlled by the terminal. The functioning takes place without any collision. The communication is of the “semi-duplex” type (communication in only one direction allowed at a time). The card sends a response to the terminal only after the latter has posed a question to it.

The current trend is to integrate the card in more and more omnipresent data processing. To do this, so-called open operating systems have been developed, such as “JavaCard”, “Multos”, “Windows for Smartcards” and “Camille”.

These operating systems enable the user to load applications and thus to enhance on each occasion the use which can be made of the card. In addition, they also enable the applications embedded in the card to communicate with each other.

With regard to the “JavaCard” system, this is based on an architecture in four layers, as depicted in FIG. 3. The highest layer contains the user applications, said to be “on-board” 28 which are based on Java libraries 30 dedicated to the card 2. These libraries are a subset of the Java APIs (from the English “Application Program Interface”, that is to say application program interface) and constitute the second layer of the “JavaCard” system. The code of the applications is expressed in a byte code which is interpreted by the virtual machine 32. The latter runs the application programs and is based on a basic operating system managing the writing in memory, the inputs/outputs, the calls on the cryptographic routines ensuring security, and finally the support of the various ISO standards. The two lowest layers 32 and 34 are stored in the fixed memory ROM 18 of the card 2.

Each method has available its own execution stack containing the variables and parameters which it manipulates. The virtual machine uses registers for storing the so-called local variables (variables allocated during the method as well as the parameters thereof).

Security in a virtual machine 32 is an important problem, since it is a support for executing the mobile code, the latter being able to come from various uncertain sources. Thus the virtual machine 32 may be caused to execute a code which endangers the reliability of the system or other components.

In the light of these difficulties, current techniques aim at ensuring that the limited-memory device does not itself have to perform the checking of the programs which it is to integrate, this task either being carried out upstream or dispensed with, relying on approval certificates which guarantee the integrity of the programs.

More particularly, the solutions proposed are based on:
the use of a defensive virtual machine;
the use of an external certification body with the help of cryptography validating the innocuousness of the code;
the use of “byte code” checking algorithms.

The defensive virtual machine is said to be “suspicious”. During execution, it checks that each byte code element is not used injudiciously (for example, it checks that each byte code has the correct number of parameters on the execution stack, or also that each method invocation is valid). This solution has the fault of greatly straining the performance of the virtual machine.

The solution using an external certification body has the advantage of causing few modifications on the virtual machine; however, this solution is very expensive to deploy and greatly impairs the open appearance of the virtual machine.

The Java specification defines a security model based on the analysis of the byte code during its loading. The purpose of this analysis is to prove the innocuousness of the program loaded; in the contrary case, it is rejected. The chip card has available capacities which are deemed to be too limited to carry out this analysis. This is why various solutions have been proposed.

According to another known approach, an external pre-processing is carried out making it possible to obtain the code of additional information or evidence enabling the card to check the code during loading. Other approaches aim at integrating a byte code checker in the resources of the limited-memory device.

Thus it was proposed, in the patent document WO-A-01 14958, to carry out an “off-card” modification of the code of the program, so that the latter keeps its original meaning but becomes easier to check. This simplifies the checking process by allowing checking in a single phase. However, it has the drawback of requiring modifications to the program code and excludes the use of certain optimisation techniques.

According to yet another approach, used in particular for the KVM (from the dedicated term “K-virtual machine”) virtual machine, the checking consists in carrying out a pre-calculation and adding its result to the code. This pre-calculation added is then used by the byte code checker to allow the use of simpler algorithms. It is then a case of a simplified version of the technique known as checking carrier code (also known by the term “PCC”, from the English “Proof Carrying Code”, that is to say proof carrying code).

In Java language, the byte code is specified so that it can check the integrity of the operations of a program statically. The checking is broken down into two parts:
a structural check; and
a typing check (the type inference).

The type inference can be considered to be a data stream analysis, the data being the memory cells manipulated by the instructions, expressed in byte code, of the virtual machine. Its purpose is to defend the virtual machine, as well as the basic system, but also the user applications, by refusing any code which might impair their integrity. The principal role of the type inference is to ensure that each instruction which composes a program manipulates the data (the memory) and triggers the execution of other processings whilst respecting their specifications.

Type inference is a process of static code analysis which takes place during the phase of loading an application. It is deemed to be an expensive algorithm in terms of execution time, and also in terms of memory consumption. This may greatly weigh on the processor loading the code into the virtual machine 32. Thus type inference is normally executed by an external third party when the hardware constraints are deemed to be too great (such as in a chip card for example).

For more information on this aspect, reference can be made to the publications: Rose, E. and Rose, K. H. “Lightweight bytecode verification”; Workshop on Formal Underpinnings of the Java Paradigm, OOPSLA '98, 1998; and Necula, G. C. and Lee, P. “Proof Carrying Code” Proceedings of the 24^{th} ACM SIGPLAN-SIGACT Symposium on Principles of Programming Languages (POPL '97), pages 16-119, Paris, January 1997. In the articles by Colby, C., Necula, G. C. and Lee, P. “A proof carrying code architecture for Java” Computer Aided Verification, 2000 and Necula, G. C. “A scalable architecture for proof carrying code”, Fifth International Symposium of Functional and Logic Programming, 2001, the inventors of the PCC describe how to adapt this technique to Java byte code checking and on-board, checking.

Known solutions offer the same level of security, and greatly simplify the work of the on-board checker. However, they are appreciably less flexible than a completely embedded solution, since any application not having its certificate with it will be rejected, even if it is valid. The main defect of PCC solutions is that the proof must be loaded and stored in the card. The addition of a component to be loaded does not help to reduce the bottleneck which the application loader constitutes. In addition, the proof must be stored in persistent memory (EEPROM) 22 because of its size, and therefore suffers from problems of speed and reliability.

The guarantees afforded by type interference are numerous and varied in nature. The most important concerns the security of the virtual machine 32. It is sought to guarantee the coherence and consistency of this.

In the light of the above, the invention proposes, according to a first aspect, a method for checking a program during its phase of integration into an electronic device, the program being organised according to types linked by parentage relationships, each type being identified by a respective code, the method comprising a phase of unifying types aimed at determining their closest common ancestor, characterised in that the code is described in the form of a bit pattern according to a formalism which expresses the parentage of the type with which it is associated,

and in that the unification phase comprises a logic combination of patterns assigned to the types to be unified, producing the pattern of the type which is their closest common ascendant.

Advantageously, for any type having an ascendant, its pattern contains at least one bit which is identical in terms of value and position to a corresponding bit of the pattern of its direct ancestor.

The pattern of a given bit preferably comprises a number of bits at a predetermined logic state which is a function of the distance of the type of the common ancestor.

In a preferred embodiment, a memory is used subject to wear by wearing logic state transitions, in order to store at least one pattern intended to be subjected to a logic combination or which results from a logic combination in the unification phase.

It is then possible to envisage a pattern allocation formalism which establishes a preponderance of a logic state in all the patterns which minimises the number of wearing transitions necessary for effecting the storage of the patterns in the memory.

Preferably, the storage cells of the memory are initialised to the logic state from which the transition is in the opposite direction to the direction of the wearing transition.

When the wearing transition is in the direction from the logic 0 state to the logic 1 state, the logic combination consists preferably in performing a logic operation of the AND type between each pair of bits of the same rank of the combined patterns.

When the wearing transition is in the direction from the logic 1 state to the logic 0 state, the logic combination preferably consists in performing a logic operation of the OR type between each pair of bits of the same rank of the combined patterns.

Moreover, the method can be implemented for a program which is in the form of a set of code sections, each section being identified by a marking which corresponds to an instruction which can be attained from a branch, by proceeding with the checking by sections in a given order of sections according to a given heuristic.

In this case, the order of the sections to be checked may be the order of succession of a checked section followed by its section which is its successor.

The order of sections to be checked may also be given by the first marked section.

Advantageously, a volatile memory is used as a cache for storing candidate patterns at the logic combination step, and the candidate patterns are chosen dynamically and by prediction according to branch points in the program to be checked.

It is then possible to select, for storage in the volatile memory, those of the patterns which correspond to types liable to be the subject of unification after a given time, and to make the selection of the patterns to be stored with reference to a control flow graph for the program to be checked.

Conversely, it is possible to select, for unloading the volatile memory, those of the patterns which correspond to types more liable to be the subject of unification after a given time, and to select the patterns to be removed from memory by reference to a control flow graph for the program to be checked.

The control flow graph is preferably established from previously determined markings and instructions which branch to these markings. In the embodiments envisaged, the checking method is carried out with the execution medium for the device intended to execute the code of the program which is the subject of the check. The invention is particularly advantageous for performing the check in an electronic device of the chip card type.

According to a second aspect, the invention concerns an electronic device for checking a program during its phase of integration in an electronic device, the program being organised according to types linked by parentage relationships, each type being identified by a respective code, the said device comprising means of unifying types in order to determine their closest common ancestor,

characterised in that it comprises means of identifying the parentage of types, the identification of a type being made on the basis of a pattern of bits which constitutes its code according to a given formalism,

and in that the unification means comprise means of logic combination of patterns assigned to the types to be unified, producing the pattern of the type which is their closest common ancestor.

This checking device can be produced so as to be able to execute the method according to the first aspect.

According to a third aspect, the invention concerns an electronic device for loading and executing a program organised according to types linked by parentage relationships, each type being identified by a respective code,

characterised in that it integrates a checking device according to the second aspect.

In the embodiments envisaged, this device is produced in the form of a chip card.

The invention and the advantages which stem therefrom will emerge more clearly from a reading of the following description of preferred embodiments, given purely by way of non-limiting examples, with reference to the accompanying drawings, in which:

FIG. 1, already described, is a diagram which illustrates the principle of integrating a code checker in a portable device such as a chip card;

FIG. 2, already described, is a block diagram of the functional elements which constitute a micromodule of an open-architecture chip card;

FIG. 3, already described, is a diagram illustrating the layers constituting a virtual machine;

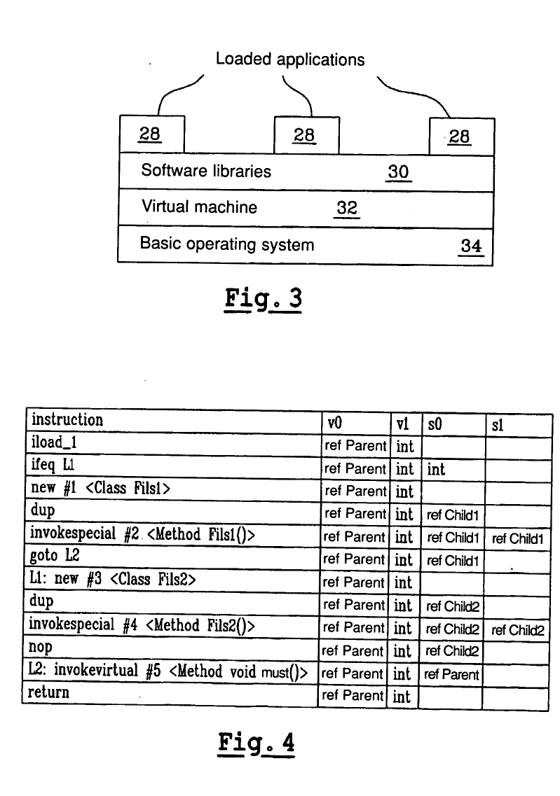

FIG. 4 is an example, presented in table form, of a typical and novel inference trace after modification of the junction hypothesis;

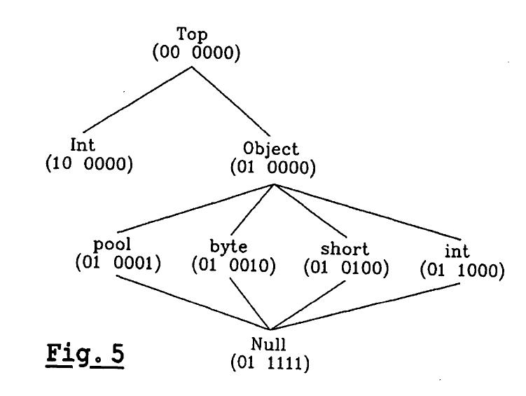

FIG. 5 depicts an example of non-stressing unifying trellis encoding, according to the preferred embodiment; and

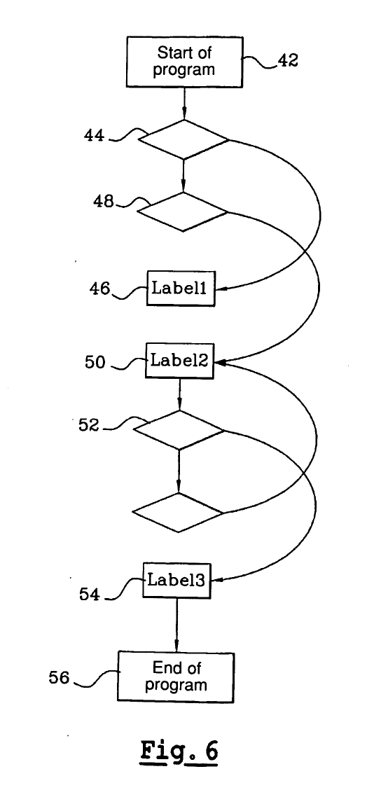

FIG. 6 is an example illustrating the use of a control flow graph for accelerating the checking by means of a software cache.

Before describing the embodiments of the invention, the principles of a byte code check in a virtual machine 32 by means of a so-called “reference” algorithm, described in patent document U.S. Pat. No. 5,668,999, will be presented.

To facilitate understanding of the reference algorithm, also known by the term type inference algorithm, its description will be used by means of examples applied to Java language.

As described previously, the Java virtual machine is a stack machine. It performs operations on working variables known as local variables, as well as on a stack. The aim of this method is to determine the type of each of the local variables and of each of the cells in the stack for each point in the program. To do this, advantage is taken of the fact that the Java byte codes are typed.

Hereinafter, the term “execution context” is given to the local variables/stack pair. It contains typing information.

The type inference is based on a static analysis of the code. Each instruction of Java byte code can be modelled as taking its parameters on the stack or in the local variables, and generating a result on the top of the stack, or in a local variable, if necessary. For the Java objects and variables allocated during the method, their types are determined by means of the byte code used for the creation thereof.

There exists a relationship of order between the classes which will be illustrated by the following example.

There are two classes “Parent” and “Child”, such that “Child” is a sub-class of “Parent” linked by the code:

“Child class extends Parent
{
public static Parent m( )
{
return new Child( ) ;
}

The method “Child m( )” affirms returning a type class “Parent”, or returns a type element “Child”. A problem is posed during the check: is “Child” compatible with “Parent”? The reply is in the affirmative, since “Child” is a sub-class of “Parent”. This example illustrates the need for an operation for determining whether one type is compatible with another.

More simply, using the order relationship, a function is built which makes it possible to state whether it is possible to use one type instead of another.

Behaviour of T Vis-à-Vis the Order Relationship

The type designated “T” is the root of the trellis; it is compatible only with itself. It is the largest element in the trellis. A variable of the T type is an unusable variable.

Behaviour of “Null” Vis-à-Vis the Order Relationship

The type “null” is the element forming the part of the trellis containing the Java classes. It is the smallest element of this part. It is therefore compatible with all the Java classes.

Unifier and Fixed Point

The example whose type inference trace is given in FIG. 4 illustrates another particularity of the type inference algorithm. For the two paths in the program, two different hypotheses are established on the type of the variable at the stack top. The first solution is to mark this as being of type T, and therefore not usable. This is too restrictive: the method “must( )” is a method defined in the “Parent” class whose Java code is valid. This is because both “Child1” and “Child2” have inherited this method.

At the output from the block “if-else”, it is necessary to put the two hypotheses on the variable at the stack top in relationship. Statically, it is not possible to determine which of the two is correct. Starting from the remark that Parent is the mother class of “Child1” and “Child2”, it is possible to state that, at the output from the block “if-else”, the stack top contains a reference to an element of the “Parent” type, the only hypothesis compatible with those obtained by type inference on each of the paths in our program.

In this way a kind of joining of the hypotheses is achieved. This joining is referred to as “unification”. In this way a new relationship is defined which consists in finding the “common parent” for two types. As the trellis is bounded upwardly, it is possible to define and use it. It is termed a “unifier” and is designated by the symbol “∩”.

In the mathematic theory relating to trellises, this operation consists in determining the common parent of two nodes. This node is referred to as the LUB (from the English terminology “least-upper-bound”). The complexity of this operation increases rapidly as the depth of the trellis increases. Thus it is non-trivial to put it in place in the context of a limited-memory device, such as a chip card.

In addition it may be necessary to reiterate the type inference process on a section of code. This is because, if hypotheses are called into question at the point of entry of a code section, it is necessary to rework it with the new hypothesis. The number of iterations is necessarily finite, since each unification helps to take the types of the variables back towards, T, which will be achieved in the worst of cases. This is because the transformations used are monotonic functions.

The following Java program illustrates a search for a fixed point:

```
“public static void m(boolean b)
{
Object o=null;
while (b)
    {
    o=new Object;
        }
    }
```

At the first passage, the local variable v1 is of the “null” type. A first type inference is executed on the section of code corresponding to “while”. In this, an “Object” is stored in the local variable v1. Next the start of the “while” is switched to, and therefore a unification is effected between the two hypotheses. The local variable v1, which was of the “null” type at the first passage, is now of the type “ref Object”, since “null” is compatible with all the Java classes. It is necessary to rework the section of code corresponding to “while” in order to see whether the new hypothesis is compatible with this section of code. In the example, it is, and the program is therefore accepted.

The above is referred to as a search for a fixed point, since the type inference process is iterated continuously when an equilibrium is achieved, or more exactly when the unifications no longer modify the typing information.

Reference Algorithm

The algorithm in this section is described in its most generic form, which does not entirely correspond to that used subsequently, since it does not have any form of optimisation.

For each of the instructions used, a kind of table is used containing the type of each of the local variables, that of the elements in the stack, and the value of the stack index, referred to as TOS (from the English “top of stack”, that is to say the top of the stack). (In English terminology, this table is known by the term “type frame”.) In addition, a flag is also available for each instruction; it illustrates the fact that the typing information of the corresponding instruction has, or has not, been modified by one of the last unifications which was effected. This flag can take two values: “changed” (changed) or “unchanged” (unchanged).

The reference algorithm comprises two successive phases, designated respectively “initialisation” and “principal loop”, the principal steps of which are summarised as follows.

Initialisation

initialisation of the information for each program instruction. Position all the instructions at the “unchanged” state, apart from the first instruction, which will be positioned at the state as “changed”;
fill in the typing information thereof used in the signature, the variables not having a type are initialised with T, initialise its TOS with the value 0;
for the other instructions I;
set the flag of I to the value “unchanged”;
initialise the TOS to −1 (this to mark that this instruction has not yet been visited).
   Principal Loop
as long as there remain instructions having their flag at the value “changed”;
choose an instruction marked as “changed”; this is denoted I;
mark I as “unchanged”;
simulate the execution of I on the typing information associated with it. If this simulation fails, the method is rejected. The “type frame” is denoted R;
for each of the successors S of I;
denote 0 the “type frame” of I, and R that of S;
if the TOS associated with S is equal to −1, R=0 (and the TOS of I is also copied in that of S);
if not, apply the unification of R and O. The result is denoted R∩0 (if the TOSs of the two “type frames” are different, the check fails);
if R∩0≠R, mark S as “changed”, R∩0 becomes a new “type frame” of S.

The principal loop is iterated as long as there are instructions marked as “changed”. Stoppage takes place when a stable position is reached, hence the use of the term fixed point. The simulation of the execution consists, as described previously, in verifying the parameters present on the stack (they are in sufficient number, and their types are those expected), and then updating the “type frame” according to the byte code executed. It is thus verified that there is no upper and lower overflow of the stack, and also that the typing is correct.

The aspects to be considered for transposing these verification concepts in the context of a chip card will now be dealt with.

The main problem lies in the limits of processing and storage resources inherent in the cards, as presented above.

In addition, from the byte code, it is necessary to find the type of each of the fields manipulated. This operation is tricky. What is more, it is executed many times during the type inference, and consequently requires many transits through the structures of variable sizes. One solution is to construct an effective internal representation.

Typing Inherent in the JavaCard Byte Code

The JavaCard language requires adapted typing, which involves modifications and adaptations to the algorithms described above, particularly with regard to the trellis of the types and sub-routines.

Trellis of Types

An example of a trellis of JavaCard types is depicted in FIG. 5.

In the above, it is found that the type inference requires many invocations of the unification function.

The most standard way of implementing it consists in constructing an ordered structure in order to represent the trellis. This solution cannot readily be envisaged in the context of the microprocessor card since it would require large quantities of memory. The most standard way of implementing in a highly constrained environment consists in using a series of tests in cascade according to the two types to be unified. This solution is not optimal.

The solution adopted in the embodiments will be described in the context of programs loaded in a device, in particular a chip card 2, which makes it possible to effect a complete type inference, by virtue of techniques and optimisations in accordance with the invention.

The description deals first of all with the accelerating mechanisms for the unification, followed by an optimisation of the management of the fixed points based on the use of software caches.

Effective Management of the Unification

The embodiments deal with the problem posed by the complexity of the inference by two solutions: a unification table and, optionally, an effective and non-stressing unifying coding for the memories subject to wear by transitions in a certain direction.

Unification Table

A first solution used by the embodiment consists in pre-calculating the type unification rules. There is then obtained a table with two inputs (the two types t1 and t2 to be unified), which supplies the response to the question what is t1∩t2 equal to. There is then posed the problem related to the infinity of types available: it is in fact possible to load a large number of classes in the chip card. The addition of a new class would then give rise to the creation of a new row or column in the unification table, as well as the calculation of the result of the unification thereof with all the types already present in the card at this moment.

One example of a portion of a unification acceleration table is given in Table I below. (The symbol “T” (standing for “top”) designates the common parent of all the types, that is to say the top of the trellis.)

TABLE 1
Example of a portion of
a unification acceleration table

| | Top | int | Object | array | byte | short | int | null |
|---|---|---|---|---|---|---|---|---|
| Top | Top | Top | Top | Top | Top | Top | Top | Top |
| int | Top | int | Top | Top | Top | Top | Top | Top |
| Ob- | Top | Top | Object | Object | Object | Object | Ob- | Ob- |
| ject | | | | | | | ject | ject |
| bool | Top | Top | Object | bool | Object | Object | Ob- | bool |
| | | | | | | | ject | |
| byte | Top | Top | Object | Object | byte | Object | Ob- | byte |
| | | | | | | | ject | |
| short | Top | Top | Object | Object | Object | short | Ob- | short |
| | | | | | | | ject | |
| int | Top | Top | Object | Object | Object | Object | int | int |
| null | Top | Top | Object | bool | byte | short | int | null |

The use of a table for making the unification is easy to set up. In addition, the table being calculated once and once only, it can thus be stored in the ROM memory 18 of the card 2.

Through this approach, the unification is reduced to a reading in a two-input table in the majority of cases.

Effective and Non-Stressing Unifying Coding

The information manipulated during the inference is the types. For each type, a coding is established according to a formalism which expresses its parentage. This coding is used to obtain a more effective unification.

To this end, a technique is used implementing a bijection of the operations on the trellises to the Boolean operations. The encodings used make it possible to find the common parent of two elements of a trellis by means of a composition of logic functions. The result, which constitutes the unification, then renders the code which corresponds, according to the formalism established, to the common parent of two types.

In practice, the typing information must, in the majority of cases, be stored in persistent memory 22, in particular of the EEPROM type, because of their size. However, this type of memory is subject to stress. More particularly, the memory suffers from wear occasioned by a cumulation of logic state transitions in a particular direction, in this case from 0 to 1. Conversely, the operation consisting in making a bit fall from 1 to 0 in EEPROM is non-stressing (it does not damage the corresponding memory cell).

Starting from the fact that, during a unification, the types in the trellis are taken back to the type T, the formalism adopted aims at ensuring that this operation produces only transition of the EEPROM bits from 1 to 0.

This approach is illustrated by the example depicted in FIG. 5.

FIG. 5 depicts a case of a non-stressing unifying trellis. The common parent of all the types, at the top of the trellis, is designated Top (for “top” in English).

The formalism used in the embodiment, adapted to avoid as far as possible stressing transitions in the EEPROM memory 22 of the card 2, fixes as a code for this common parent a pattern formed by bits at the 0 state. The number of bits forming this pattern is chosen according to the maximum number of types in the trellis which share the same common ancestor. Every type is coded with a pattern comprising the same number of bits. In the example, six bits constitute a pattern, the common parent T having the pattern “00 0000”. It is ensured in particular that this number of bits makes it possible:
firstly to allocate to each type of trellis a single pattern; and
secondly to express, on the basis of the number of bits at the 1 state, the distance of the corresponding type from the top of the trellis T, that is to say its depth in the trellis (in terms of number of ancestors connecting this type to the common parent). In the example, this distance is indicated directly by the number of bits at the 1 state, except for the case of the “Null” type which constitutes the bottom of the trellis, to which a separate pattern is allocated, in this case “01 1111” in the example.

It should be noted that, for a given type (apart from the common parent T), its pattern comprises at least one bit which is identical in value and position to the pattern of its direct ancestor.

For a given type having a direct ancestor which is not the common parent, each bit at the 1 state of this parent is situated at the same position in the pattern of this given type. (The latter also comprises an additional bit at the 1 state which is specific to it and makes it possible to distinguish it between other direct descendents of this direct common ancestor.)

Thus, when there exist several types having a common ancestor, a simple logic AND operation between the patterns of two patterns makes it possible to reproduce the pattern of the direct common ancestor. The AND operation between patterns consists in performing an AND operation between each of the bits at the same position of the patterns. In this way the unification of the types is performed by this AND operation on their patterns.

By way of illustration, it is ensured that the combination AND of the patterns allocated to the types “bool” and “short” in FIG. 5, that is to say (01 0001) AND (01 0100): 0 AND 0=1, 1 AND 1=1, . . . 1 AND 0=0, makes the pattern 01 0000 which corresponds to their common parent “Object”.

The most important property of this encoding is that it is particularly adapted to storage in EEPROM: it is possible to store the typing information in the EEPROM in particular, since the former may be large compared with the other available memories of the chip card. The stress on the EEPROM is limited when bits are made to fall (passage from 1 to 0). The unification being reduced to a logic AND, applying it to two types, only bits from 1 to 0 are changed and never from 0 to 1. Thus the stress is considerably reduced and the service life of the EEPROM is increased.

A coding of this sort can be adapted to any type of EEPROM. This is because some have reverse properties for stress in write mode, that is to say a stressing transition occasioned by passage from 1 to 0. In this case, the coding is changed so that the unification is reduced to a logic OR.

More particularly, the logic states of the patterns are systematically reversed with respect to those used for the AND combinations described above. To resume the example of FIG. 5, the pattern 11 1111 is then allocated to the common parent T, the pattern 01 1111 to the type “Int”, etc. It can easily be verified on the basis of simple Boolean logic principles that in this case the same results are obtained with the logic OR operation in place of the logic AND operation in the context of FIG. 5.

Where required, the coding can be made more compact by using a more complex Boolean function, by means of storage in EEPROM memory which may occasion stressing transitions.

Effective Management of the Fixed Points

It will be recalled that type inference is a search for fixed points. The encoding of types described previously appreciably contributes to the reduction in the stress on the EEPROM. The embodiment also makes it possible to:
accelerate the unification,
optimise the use of the RAM memory 20, and
have a generic algorithm both in the case where the verification may be made in RAM, and also when recourse is had to the EEPROM. These advantages are obtained firstly by using heuristics for selecting the marking (also known by the term “label”) to be verified, and secondly by combining this selection with the control of a software cache, that is to say part of the RAM memory used as cache memory for rapid access to the data liable to be processed in the immediate future. The aim then consists in loading in the cache the patterns of the types for which a short-term unification operation is envisaged. These patterns, referred to as “candidate” patterns, are chosen by predictional techniques defined by a general rule referred to as “heuristic”. The software cache memory capacity being limited, a heuristic must make it possible to predict not only the patterns which are soon to be combined but also, conversely, to predict those more liable to be combined in order to eliminate them. This entails dynamic changing management. Moreover, heuristics are advantageously used which demand only a little calculation in order not to burden the resources used.
   Heuristic for Selecting Marking to be Checked

The optimised type inference algorithm described above works at the branching points of the JavaCard programs. During the inference, it is possible to have several labels marked as being to be checked. This therefore leads to electing one of them and checking the corresponding code section. It is therefore necessary to have a choice criterion. In order to measure and compare the possible heuristics, a ratio, denoted r, will be defined as follows:
r=Number of unifications/Number of markings.

It makes it possible to measure the number of passages necessary per section of code to achieve a fixed point.

The “Random” Heuristic (Random)

This heuristic can be used as a reference. It makes it possible to obtain good results on an evaluation set. It consists in choosing at random the next marking to be checked amongst the types marked.

The “Next” Heuristic (Next)

The “Next” heuristic is relatively simple. It consists in electing the marking which is the successor of the marking which has just been checked. In this way the necessary number of linear checking passes are made.

The “Lazy” Heuristic (Search for Simplicity)

The “Lazy” heuristic is optimum in terms of efficacy and simplicity. It consists in taking as a marking to be checked the first marked. In general, the JavaCard programs result from the conversion of Java code compiled by means of the Java development kit, known by the English term JDK, standing for “Java Development Kit”. However, this generates fairly linear code. The stopping points of the programs are thus fairly often found at the end of the byte code. This finding is exploited by therefore using systematically the first marking as being that to be checked. Thus the start of the program is worked out in order no longer to return to it subsequently. The “Lazy” heuristic makes it possible to obtain a value of 1.3 for the ratio r defined above.

Finer heuristics can be put in place, in particular using the check flow graph of the program checked. The graph can in particular serve to control the software caches.

Optimum Caches

The judicious use of software caches makes it possible also to gain an acceleration factor, particularly during the checking of programs (such as applets) which are relatively large, since they appreciably reduce the number of writings in EEPROM. They also considerably accelerate the checking of small programs by making no writing in EEPROM.

To make the type inference, it is necessary to detect the vanishing points of the program. In doing this, it is easy and “free” to construct the check flow graph thereof. Certain methods require more than 4 Kb of memory in order to be checked, and an advanced chip card in the prior art has available 8 Kb of RAM). It can therefore be envisaged checking the applications using such methods.

In the implementation, a software cache is set up between the EEPROM and the RAM in order to best manipulate the type frames. This involves a phase of electing data to be deleted (eliminated) from the cache during checking, and therefore a cache management policy.

To this end, it is possible to use conventional policies, for example of the LRU type (elimination of the data used least recently, from the English “least recently used”).

However, it is advantageously possible to exploit the fact that, since the check flow graph is available, it is easy to determine the data present in the cache which are pertinent and which must therefore be kept. Knowing the type of the selection heuristic for the marking to be checked, it is possible easily to assess the pertinence of a cache in the data according to a given mechanism. By way of example, it is possible to refer to a mechanism described in the article by Chi-Keung Luk and Todd C. Mowry “Compiler-based prefetching for recursive data structures”, ACM SIGPLAN Notices, 31(9): 222-233, 1996.

The use of the check flow graph for determining the cache management policy will be shown by the following example. The check flow graph is supplied in accordance with the example illustrated with reference to FIG. 6.

Table II indicates a possible execution trace for the type inference for this example.

TABLE II
Possible execution trace of
the type inference for the example of FIG. 6

| | |
|---|---|
| 1. | Loading of the current context with that of the |
| | program start |
| 2. | Unification with the label1 |
| 3. | Unification with the label2 |
| 4. | Selection of label1 |
| 5. | Unification with the label2 |
| 6. | Selection of label2 |
| 7. | Unification with the label3 |
| 8. | Unification with the label2 |
| 9. | Selection of label2 |
| 10. | Unification with the label3 |
| 11. | Unification with the label2 |
| 12. | Selection of label3 |
| 13. | End of the check |

The assumption is adopted that the “Lazy” heuristic is used for selecting the next marking (label) to be checked, and that an attempt is made to carry out the unifications in the RAM 20 (i.e. in the cache). The checking trace given in FIG. 6 is produced as follows, for the case of a cache which is initially empty and has two cells:
the first step is to load the current descriptor by means of typing information associated with the start of the program 42;
the first code section is checked and a conditional branching 44 intended for the marking “label1” 46 is achieved. It is therefore necessary to unify the type “frame” of the marking “label1” with the current one. The typing information of the marking “label1” will therefore be loaded into the cache;
it is then necessary to unify 48 with the marking “label2” 50 at the time of the encounter with the second branching 48. Having available a cache cell, the information of the marking “label2” is loaded therein;
the marking “label1” is chosen in order to check the corresponding code section, in accordance with the use of the “Lazy” heuristic;
it is necessary to unify with the marking “label2”; however, the latter is in the cache. The unification therefore takes place in RAM;
next marking is selected, that is to say “label2”;
the conditional jump 52 is arrived at, having at its destination the marking “label3” 54. There is no corresponding typing information in the cache. The latter is full (it contains the typing information for the markings “label1” and “label2”). It is therefore necessary to elect one of these markings in order to release a cell in the cache and load therein the typing information for the marking “label3”. Referring to the check flow graph, it can be seen that only the markings “label2” and “label3” are accessible from the current code section (a further level in the graph can be looked at: from the marking “label2” the markings “label2” and “label3” are accessible; from the marking “label3”, no marking is accessible). Thus it is possible to eliminate the marking “label1” for the cache and update its copy in EEPROM;
the check continues without hindrance as far as the end of the program 56.

Without using the cache, it would have been necessary in this example to perform seven unifications in EEPROM (that is to say seven writings in EEPROM). With the cache, the typing information of the marking “label1” in EEPROM is updated once and once only. In addition, this updating is not necessary since the marking “label1” is no longer accessible by any path in the program at this moment in the verification. Its typing information is therefore no longer necessary.

An illustration is given here of the possibilities of the use of the check flow graph of the programs to be checked in order to best control the cache. In doing this an optimum cache is approached (i.e. the correct information at the correct time in the cache).

As constructing the check flow graph is inexpensive in the case in question, it is possible to use it not only for controlling the software cache but also for improving the selection heuristic for the label to be checked.

The preferred embodiment makes it possible to obtain simple checking systems which open up the possibility of the use of a checker which is entirely loaded in a microprocessor card or other limited-memory device.

It will be clear to a person skilled in the art that the invention allows many variants and equivalences according to the conditions and criteria of its use, with regard to logic, hardware or environment.

1. A method for checking a program during its phase of integration in an electronic device, the program being organised according to types linked by parentage relationships, each type being identified by a respective code, the said method comprising a phase of unification of types aimed at determining their closest common ancestor,
wherein the said code is described in the form of a pattern of bits according to a formalism which expresses the parentage of the type with which it is associated,
and wherein the said unification phase comprises a logic combination of patterns allocated to the types to be unified, producing the pattern of the type which is their closest common ancestor.

2. A method according to claim 1, wherein, for any type having an ancestor, its pattern contains at least one bit which is identical in terms of value and position to a corresponding bit of the pattern of its direct ancestor.

3. A method according to claim 1, wherein the pattern of a given type comprises a number of bits at a predetermined logic state which depends on the distance of the said type from the common ancestor.

4. A method according to claim 1, wherein use is made of a memory subject to wear through wearing logic state transitions in order to store at least one pattern intended to be subjected to a logic combination or which results from a logic combination in the said unification phase.

5. A method according to claim 4, wherein the pattern allocation formalism establishes a preponderance of a logic state in the set of patterns which minimises the number of wearing transitions necessary for effecting the storage of the patterns in the said memory.

6. A method according to claim 4, wherein the storage cells of the said memory are initialised to the logic state from which the transition is in the opposite direction to the direction of the wearing transition.

7. A method according to claim 4, wherein the said wearing transition being in the direction from the logic 0 state to the logic 1 state, the logic combination consists in performing a logic operation of the AND type between each pair of bits of the same rank of the combined patterns.

8. A method according to claim 4, wherein the said wearing transition being in the direction from the logic 1 state to the logic 0 state, the logic combination consists in performing a logic operation of the OR type between each pair of bits of the same rank of the combined patterns.

9. A method according to claim 1, implemented for a program which is in the form of a set of code sections, each section being identified by a marking which corresponds to an instruction which can be reached from a branching, wherein the said checking is carried out by sections in a given order of sections in a predetermined heuristic.

10. A method according to claim 9, wherein the order of the sections to be checked is the order of succession of a checked section followed by its section which is its successor.

11. A method according to claim 9, wherein the order of the sections to be checked is given by the first marked section.

12. A method according to wherein use is made of a volatile memory as a cache for storing candidate patterns for the logic combination step, and in that the said candidate patterns are chosen dynamically and by prediction according to branching points in the program to be checked.

13. A method according to claim 12, wherein there are selected, for storing in the said volatile memory, those of the patterns which correspond to types liable to be the subject of unification after a given time, and in that the said selection of the patterns to be stored is made by reference to a check flow graph of the program to be checked.

14. A method according to claim 12, wherein there are selected, for emptying of the said volatile memory, those of the patterns which correspond to types more liable to be the subject of unification after a given time, and in that the said selection of the patterns to be emptied is made with reference to a check flow graph of the program to be checked.

15. A method according to claim 13, wherein the check flow graph is established from the said previously determined markings and instructions which branch to these markings.

16. A method according to claim 1, wherein the said check is carried out in an electronic device of the chip card type.

17. A device for checking a program during its phase of integration in an electronic device, the program being organised according to types linked by parentage relationships, each type being identified by a respective code, the said checking device comprising means of unifying types in order to determine their closest common ancestor,
wherein it comprises means of identifying the parentage of types, the identification of a type being carried out on the basis of a pattern of bits which constitutes its code according to a given formalism,
and wherein the said unification means comprise means of logic combination of patterns allocated to the types to be unified, producing the pattern of the type which is their closest common ancestor.

18. A device according to claim 17, able to execute the method comprising a phase of unification of types aimed at determining their closest common ancestor,
wherein the said code is described in the form of a pattern of bits according to a formalism which expresses the parentage of the type with which it is associated,
and wherein the said unification phase comprises a logic combination of patterns allocated to the types to be unified, producing the pattern of the type which is their closest common ancestor.

19. An electronic device for loading and running a program organised according to types linked by parentage relationships, each type being identified by a respective code,
wherein it integrates a checking device according to claim 17.

20. A device according to claim 19, wherein it is produced in the form of a chip card.
